(19) United States
(12) Patent Application Publication
(10) Pub. No.: US 2025/0119850 A1
(43) Pub. Date: Apr. 10, 2025

(54) ELECTRONIC DEVICE AND SPATIAL REUSE CONTROL METHOD

(71) Applicant: SAMSUNG ELECTRONICS CO., LTD., Suwon-si (KR)

(72) Inventor: Junsu CHOI, Suwon-si (KR)

(21) Appl. No.: 18/984,001

(22) Filed: Dec. 17, 2024

Related U.S. Application Data
(63) Continuation of application No. PCT/KR2023/006830, filed on May 19, 2023.

(30) Foreign Application Priority Data
Jul. 15, 2022 (KR) 10-2022-0087642
Aug. 11, 2022 (KR) 10-2022-0100798

(51) Int. Cl. H04W 52/42; H04W 52/36; H04W 74/0816

(52) U.S. Cl. CPC H04W 52/42; H04W 52/367; H04W 74/0816

(57) ABSTRACT

An electronic device according to an embodiment may comprise: one or more wireless communication modules comprising communication circuitry configured to transmit/receive a wireless signal; at least one processor, comprising processing circuitry, operatively connected to the wireless communication module; and a memory electrically connected to at least one processor and storing instructions executable by the processor, wherein at least one processor, individually and/or collectively, is configured to execute the instructions and to: identify whether an SAR backoff regulation value is present for transmission power of the electronic device; set a spatial reuse parameter associated with the transmission power, on the basis of the SAR backoff regulation value; and perform communication on the basis of the spatial reuse parameter.

### CROSS-REFERENCE TO RELATED APPLICATIONS

This application is a continuation of International Application No. PCT/KR2023/006830 designating the United States, filed on May 19, 2023, in the Korean Intellectual Property Receiving Office and claiming priority to Korean Patent Application Nos. 10-2022-0087642, filed on Jul. 15, 2022, and 10-2022-0100798, filed on Aug. 11, 2022, in the Korean Intellectual Property Office, the disclosures of each of which are incorporated by reference herein in their entireties.

### BACKGROUND

### Field

The disclosure relates to an electronic device and a spatial reuse control method.

### Description of Related Art

With the advent of electronic devices such as a smartphone, a tablet PC, or a laptop, the demand for high-speed wireless connectivity has exploded. Driven by these trends and the growing demand for high-speed wireless connectivity, the IEEE 802.11 wireless communication standard is firmly established in the information technology (IT) industry as the leading and universal high-speed wireless communication standard. Early wireless LAN technology, developed around 1997, could support transmission speeds of up to 1 to 2 Mbps. Since then, the demand for faster wireless connections has led to the development of new wireless LAN technologies that improve transmission speeds, such as IEEE 802.11n, 802.11ac, or 802.11ax, as wireless LAN technology continues to evolve. In the current state-of-the-art standard, IEEE 802.11ax, the maximum transmission speeds reach several Gbps.

Today, wireless LANs provide high-speed wireless connectivity to users everywhere in society, not only in private places like homes, but also in various public places like offices, airports, stadiums, or stations. As a result, wireless LANs have had a significant impact on people's way of life, or culture, and wireless LANs have become a lifestyle in modern life.

### SUMMARY

An electronic device according to an example embodiment may include: at least one wireless communication module comprising communication circuitry configured to transmit and/or receive a wireless signal, at least one processor, comprising processing circuitry, operatively connected to the wireless communication module, and a memory electrically connected to the processor and configured to store instructions executable by at least one processor, wherein at least one processor, individually and/or collectively, is configured to execute the instructions and to: determine whether a specific absorption rate (SAR) back-off limit value for transmission power of the electronic device exists, set a spatial reuse parameter related to the transmission power, based on the SAR back-off limit value, and perform communication based on the spatial reuse parameter.

An electronic device according to an example embodiment may include: at least one wireless communication module comprising communication circuitry configured to transmit and/or receive a wireless signal, at least one processor, comprising processing circuitry, operatively connected to the wireless communication module, and a memory electrically connected to the processor and configured to store instructions executable by the processor, wherein at least one processor, individually and/or collectively, is configured to execute the instructions and to: calculate an energy budget allocated to a time window, based on a time average specific absorption rate (TAS) back-off algorithm, set a spatial reuse parameter related to transmission power of the electronic device, based on the energy budget, and perform communication during the time window, based on the spatial reuse parameter.

A method of operating an electronic device according to an example embodiment may include: determining whether a SAR back-off limit value for transmission power of the electronic device exists, setting a spatial reuse parameter related to the transmission power, based on the SAR back-off limit value, and performing communication based on the spatial reuse parameter.

### BRIEF DESCRIPTION OF THE DRAWINGS

The above and other aspects, features and advantages of certain embodiments of the present disclosure will be more apparent from the following detailed description, taken in conjunction with the accompanying drawings, in which:

FIG. 1 is a diagram illustrating an example of a wireless local area network (WLAN) system according to various embodiments;

FIG. 2 is a diagram illustrating an example of a WLAN system according to various embodiments;

FIG. 3 is a signal flow diagram illustrating a protocol for traffic transmission according to various embodiments;

FIGS. 4A and 4B are diagrams including graphs illustrating a specific absorption rate (SAR) back-off protocol, according to various embodiments;

FIGS. 5A, 5B and 5C are diagrams illustrating a spatial reuse protocol according to various embodiments;

FIG. 6 is a graph illustrating a conflict between a spatial reuse protocol and a SAR back-off protocol, according to various embodiments;

FIG. 7 is a block diagram illustrating an example configuration of a station (STA) according to various embodiments;

FIG. 8 is a graph illustrating an example of an operation of a SAR back-off protocol combined with a spatial reuse protocol, according to various embodiments;

FIGS. 9A, 9B, 9C and 9D are graphs illustrating an example of an operation of a SAR back-off protocol combined with a spatial reuse protocol, according to various embodiments;

FIG. 10A is a flowchart illustrating an example method of operating an STA, according to various embodiments;

FIG. 10B is a flowchart illustrating an example method of operating an STA, according to various embodiments.

FIG. 11 is a block diagram illustrating an example electronic device in a network environment, according to various embodiments.

### DETAILED DESCRIPTION

Hereinafter, various example embodiments are described in greater detail with reference to the accompanying drawings. When describing the various embodiments with reference to the accompanying drawings, like reference numerals refer to like components and a repeated description related may not be repeated.

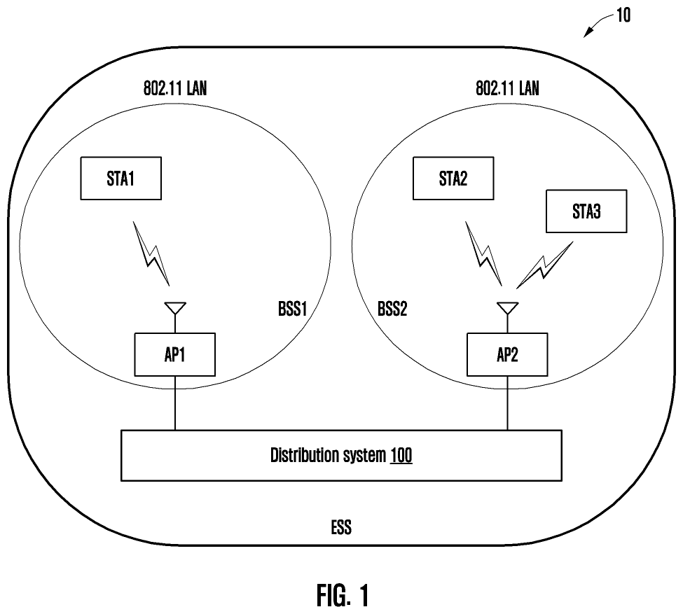

FIG. 1 is a diagram illustrating an example of a wireless local area network (WLAN) system according to various embodiments.

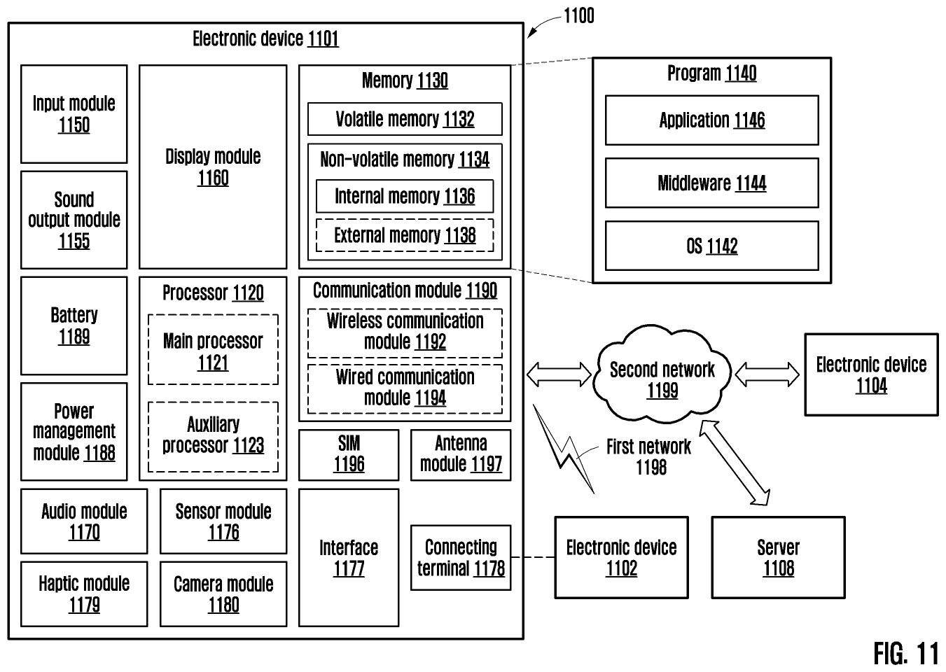

Referring to FIG. 1, according to an embodiment, a WLAN system 10 may refer to an infrastructure mode in which an access point (AP) is present in a structure of a WLAN of the Institute of Electrical and Electronic Engineers (IEEE) 802.11 standard. The WLAN system 10 may include one or more basic service sets (BSSs) (e.g., BSS1 and BSS2). BSS (e.g., BSS1 and BSS2) may refer to a set of an access point (AP) and a station (STA) (e.g., an electronic device 1101, an electronic device 1102, and an electronic device 1104 of FIG. 11) that may be synchronized with each other to communicate with each other. BSS1 may include AP1 and STA1, and BSS2 may include AP2, STA2, and STA3.

According to an embodiment, the WLAN system 10 may include at least one STA (e.g., STA1 to STA3), a plurality of APs (e.g., AP1 and AP2) that provide a distribution service, and a distribution system 100 configured to connect the plurality of APs (e.g., AP1 and AP2). The distribution system 100 may implement an extended service set (ESS) by connecting a plurality of BSSs (e.g., BSS1 and BSS2). The ESS may be used as a term to denote one network including the plurality of APs (e.g., AP1 and AP2) connected via the distribution system 100. The plurality of APs (e.g., AP1 and AP2) included in one ESS may have the same service set identification (SSID).

According to an embodiment, the STAs (e.g., STA1 to STA3) may include a medium access control (MAC) and a wireless-medium physical layer interface conforming to the IEEE 802.11 standard. The term “STA” (e.g., STA1 to STA3) may be used to collectively refer to both an AP and a non-AP STA. The STA (e.g., STA1 to STA3) may also be referred to by various terms, such as an electronic device, a mobile terminal, a wireless device, a wireless transmit/receive unit (WTRU), user equipment (UE), a mobile station (MS), and a mobile subscriber unit, or simply, a user.

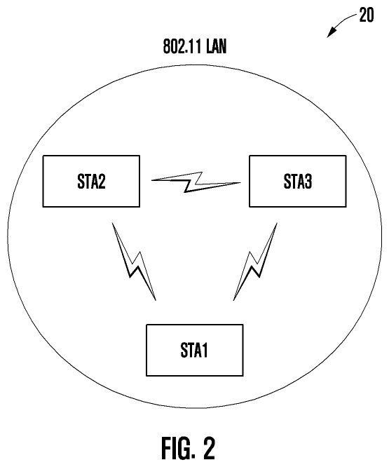

FIG. 2 is a diagram illustrating an example of a WLAN system according to various embodiments.

Referring to FIG. 2, according to an embodiment, a WLAN system 20 may represent an ad-hoc mode in which communication is performed by setting a network among a plurality of STAs (e.g., STA1 to STA3) without any AP in the structure of a WLAN of the IEEE 802.11 standard, as opposed to the WLAN system 10 of FIG. 1. The WLAN system 20 may include a BSS operating in an ad-hoc mode, that is, an independent basic service set (IBSS).

According to an embodiment, since the IBSS does not include an AP, a centralized management entity that performs a management function at a center may not exist. In the IBSS, STAs may be managed in a distributed manner. In the ISS, all STAs may be mobile STAs, and an access to a distribution system may not be allowed, and accordingly, a self-contained network (or an integrated network) may be formed.

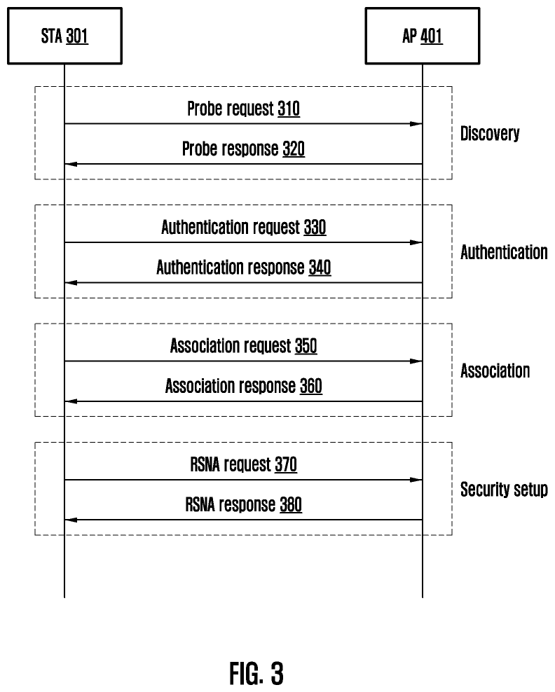

FIG. 3 is a signal flow diagram illustrating an example link setup operation according to various embodiments.

Referring to FIG. 3, according to an embodiment, the link setup operation may be performed between devices (e.g., an STA 301 and an AP 401) to communicate with each other. For the link setup, operations of discovering a network, performing authentication, establishing association, and setting up security may be performed. The link setup operation may also be referred to as a “session initiation operation” or a “session setup operation.” In addition, discovery, authentication, association, and security setup operations in the link setup operation may be collectively referred to as an “association operation.”

According to an embodiment, a network discovery operation may include operations 310 and 320. In operation 310, the STA 301 (e.g., the electronic device 1101, the electronic device 1102, or the electronic device 1104 of FIG. 11) may transmit a probe request frame to probe which AP exists and may wait for a response to the probe request frame. To access a network, the STA 301 may find a network to participate in by performing a scanning operation. The probe request frame may include information of 30 the STA 301 (e.g., a device name and/or an address of the STA 301). The scanning operation in operation 310 may refer to an active scanning operation. In operation 320, the AP 401 may transmit, to the STA 301 that transmits the probe request frame, a probe response frame in response to the probe request frame. The probe response frame may include information of the AP 401 (e.g., a device name and/or network information of the AP 401). Although FIG. 3 illustrates that the network discovery operation is performed through active scanning, the example is not limited thereto and when the STA 301 performs passive scanning, an operation of transmitting a probe request frame may be omitted. The STA 301 performing passive scanning may receive a beacon frame transmitted by the AP 401 and may perform the following subsequent procedures.

According to an embodiment, after the STA 301 discovers a network, an authentication operation including operations 330 and 340 may be performed. In operation 330, the STA 301 may transmit an authentication request frame to the AP 401. In operation 340, the AP 401 may determine whether to allow authentication for the STA 301, based on information included in the authentication request frame. The AP 401 may provide the STA 301 with a result of an authentication process through an authentication response frame. An authentication frame used for authentication request/response may correspond to a management frame.

According to an embodiment, the authentication frame may include information on an authentication algorithm number, an authentication transaction sequence number, a status code, challenge text, a robust security network (RSN), a finite cyclic group, and the like.

According to an embodiment, after the STA 301 has successfully authenticated, an association operation including operations 350 and 360 may be performed. In operation 350, the STA 301 may transmit an association request frame to the AP 401. In operation 360, the AP 401 may transmit an association response frame to the STA 301 in response to the association request frame.

According to an embodiment, the association request frame and/or the association response frame may include information related to various capabilities. For example, the association request frame may include information related to various capabilities, including a beacon listen interval, an SSID, a supported rate, a supported channel, an RSN, a mobility domain, a supported operating class, a traffic indication map (TIM) broadcast request, and/or an interworking service capability. For example, the association response frame may include information related to various capabilities, including a status code, an association ID (AID), a supported rate, an enhanced distributed channel access (EDCA) parameter set, a received channel power indicator (RCPI), a received signal to noise indicator (RSNI), a mobility domain, a timeout interval (e.g., an association comeback time), an overlapping BSS scan parameter, a TIM broadcast response, and/or a Quality of Service (QOS) map.

According to an embodiment, after the STA 301 has successfully associated with the network, a security setup operation including operations 370 and 380 may be performed. The security setup operation may be performed using a robust security network association (RSNA) request/response. For example, the security setup operation may include a private key setup operation through four-way handshaking using an extensible authentication protocol over LAN (EAPOL) frame. The security setup operation may be performed by a security scheme that is not defined in the IEEE 802.11 standard.

According to an embodiment, a security session may be set between the STA 301 and the AP 401 based on the security setup operation, and the STA 301 and the AP 401 may perform secure data communication.

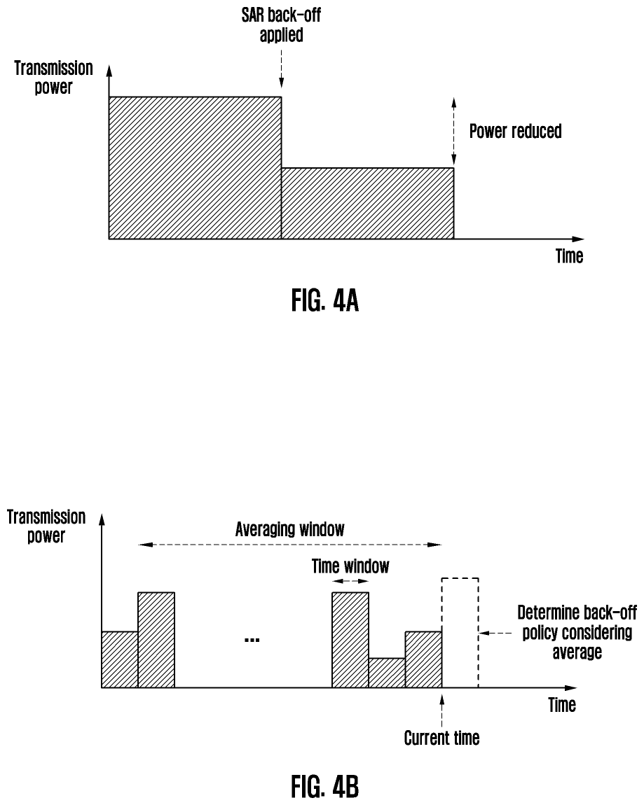

FIGS. 4A and 4B are graphs illustrating a specific absorption rate (SAR) back-off protocol, according to various embodiments.

According to an embodiment, wireless communication may be performed in a manner in which a transmitting end of an electronic device emits electromagnetic waves to a wireless medium and a receiving end of an external electronic device receives the emitted electromagnetic waves. When a person exists in a space in which electromagnetic waves are emitted and received, a significant amount of electromagnetic waves may be absorbed by a human body. Recent studies have reported that electromagnetic waves absorbed by the human body may have a number of adverse health effects. In particular, the absorption rate of electromagnetic waves rises sharply when the transmitting and receiving ends are close to the human body. Accordingly, most countries regulate the human body absorption rate of electromagnetic waves of smart devices. Since most smart devices use WLANs, WLANs are also subject to regulations. Most countries have defined standards for specific absorption rate (SAR), which refers to electromagnetic wave energy absorbed by the human body, and it is becoming mandatory for smart devices to meet the standards.

Referring to FIG. 4A, an example of a SAR back-off protocol performed in response to regulations related to the human body electromagnetic waves absorption is shown, according to an embodiment. The SAR back-off protocol may be a protocol that controls transmission power. According to the SAR back-off protocol, a smart device may use high transmission power when it is determined that the human body is not in close proximity. In addition, the smart device may reduce the transmission power when it is determined that the human body is in close proximity.

According to an embodiment, the smart device may be equipped with various connectivity solutions (CSs), such as long-term evolution (LTE) or fifth-generation wireless (5G), in addition to a WLAN. In a situation in which a plurality of CSs is operating simultaneously, a sum of electromagnetic wave energies emitted by each of the CSs may be subject to the regulation. In this case, the smart device may reduce the transmission power output by each of the CSs within the limit of an overall energy budget. As described above, controlling the transmission power to meet the regulation of the electromagnetic wave energy absorbed by the human body is called a SAR back-off protocol. An example of a SAR back-off protocol disclosed in FIG. 4A may be a protocol that uniformly applies a power limit to all transmissions at a determined timepoint (e.g., when the human body is in proximity to a device). The effect of electromagnetic waves on the human body should be calculated in terms of a total amount of electromagnetic wave energy exposed over a period of time. The SAR back-off protocol disclosed in FIG. 4A may have inefficiency. For example, when traffic is very light and very few transmissions are performed, a total amount of electromagnetic waves exposed to the human body may be negligible, even when high transmission power is used. Unnecessary enforcement of a transmission power limit may cause user experience degradation.

Referring to FIG. 4B, an example of a SAR back-off protocol (e.g., a time average SAR (TAS) back-off protocol) performed in response to regulations related to the human body electromagnetic waves absorption is shown, according to an embodiment. The TAS back-off protocol may be a protocol that limits the transmission power in terms of a total amount of electromagnetic wave energy emitted during a determined window (e.g., an averaging window). The TAS back-off protocol may limit average transmission power during an averaging window (e.g., 100 seconds or 60 seconds) to a value less than or equal to a determined value. To meet the electromagnetic waves absorption rate regulations, the TAS back-off protocol may update a TAS back-off limit value in the unit of time window that is much smaller than the averaging window.

According to an embodiment, the TAS back-off protocol may calculate, at each time window (or each update interval), a sum (e.g., an energy usage for the time window) of a product of a transmission time and the transmission power for all transmissions performed during the time window. The TAS back-off protocol may calculate an energy usage of the averaging window by adding up energy usages of all time windows included in the averaging window. The TAS back-off protocol may guide the transmission power in the time window so that an average (e.g., the average transmission power) obtained by dividing the energy usage in the averaging window by the averaging window meets the regulation. The TAS back-off protocol may calculate an energy budget allocated to each time window. Based on the energy budget allocated to a time window, the TAS back-off protocol may determine whether to perform a TAS back-off operation for the corresponding time window. The TAS back-off protocol may set a TAS back-off limit value (e.g., transmission power limit) for the time window when performing a TAS back-off operation. The TAS back-off protocol may not unnecessarily limit transmission in a subsequent time window, even when no substantial transmission is performed during a time window for which high transmission power is set.

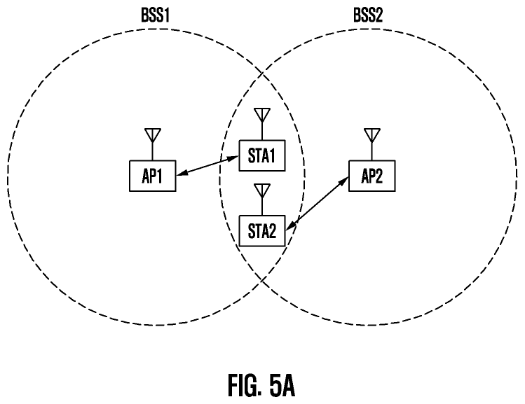

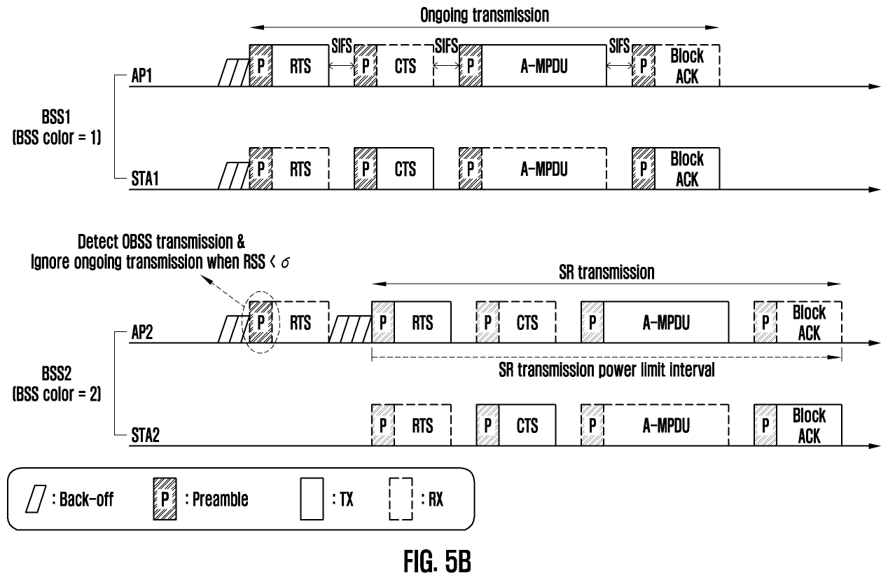

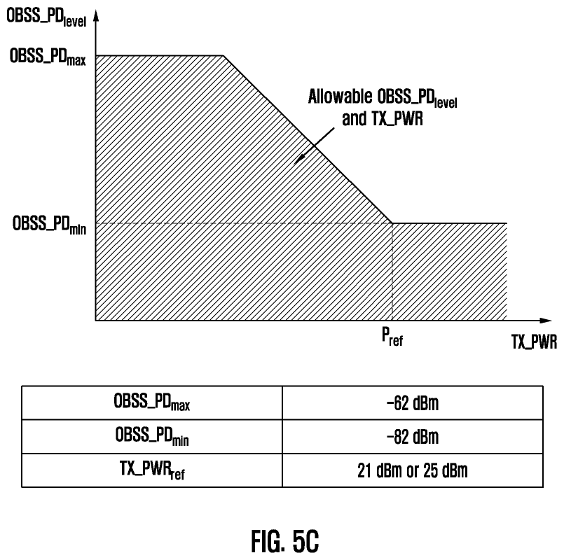

FIGS. 5A, 5B and 5C are diagrams including a graph illustrating a spatial reuse protocol according to various embodiments.

Referring to FIG. 5A, according to an embodiment, STAs (e.g., STA1 and STA2) may communicate in a dense environment. For example, STAs (e.g., STA1 and STA2) may communicate in an environment in which multiple BBSs (e.g., BBS1 and BBS2) are overlapped. BSS1 including STA1 communicatively connected to AP1 included in BSS1 may be referred to as an intra-BSS, with respect to STA1, and BSS2 overlapped with the intra-BSS may be referred to as an overlapped BSS (OBSS) (or an inter-BBS). When multiple BBSs are overlapped, communication efficiency of STA1 may decrease due to interference from another STA (e.g., STA2).

According to an embodiment, STA1 may determine whether a communication channel is occupied, by performing a clear channel assessment (CCA) operation. When transmission power (e.g., transmission power of the STA2) higher than a CCA threshold value is detected through the CCA operation, the STA1 may determine that another STA (e.g., the STA2) is occupying the communication channel. STA1 may not even get a transmission chance due to interference (e.g., STA2 occupying the communication channel) from another STA (e.g., STA2). When an influence of the interference is small (e.g., when transmission power of STA2 is low), STA1 may ignore transmission in progress (e.g., transmission being performed by STA2) and perform transmission, thereby improving efficiency of medium access control. This may be referred to as a spatial reuse (SR) operation (e.g., an SR operation).

Referring to FIG. 5B, an example of an SR operation performed according to the 802.11ax standard is shown, according to an embodiment. Adjacent BSSs may set distinct BSS colors (e.g., BSS color=1 for BSS1 and BSS color=2 for BSS2). When BSS color information is included in a physical layer header, an STA performing CCA may determine, upon packet detection, whether the packet is being transmitted within the BSS (e.g., intra-BSS) to which the STA belongs or being transmitted from an external BSS (e.g., inter-BSS). Here, in the case of a packet transmitted from intra-BSS, the STA may detect the packet based on a minimum sensitivity. In the case of a packet transmitted from inter-BSS, the STA may apply a CCA threshold value higher than the minimum security and, depending on the case, may ignore transmission in progress (e.g., ongoing transmission) and perform transmission (e.g., SR transmission).

Referring to FIG. 5C, a relationship between a set CCA threshold value and available transmission power according to a spatial reuse protocol may be confirmed, according to an embodiment. STA1 and STA2 may belong to different BSSs. For example, STA1 may belong to BBS1, and STA2 may belong to BBS2. Since STA1 and STA2 are located at a position in which part of the communication coverage of BSS1 and BSS2 overlaps, STA1 and STA2 may be stated to be in an OBSS relationship with each other. Although STA1 belongs to BSS1, STA1 may hear AP2 transmitting a wireless signal. Here, STA1 may determine that the channel is busy (e.g., the communication channel is occupied) simply by hearing the wireless signal transmitted from an AP that belongs to a BSS other than the BSS of STA1, not from an AP that belongs to the BSS of STA1. A criterion for determining that a channel is busy may be an OBSS_packet detection level (OBSS_PD level) (e.g., a CCA threshold value). For example, when a threshold value of the OBSS_PD level is −70 dBm, the channel may be determined to be busy when the signal heard from the other BSS is greater than or equal to −70 dBm. In this case, when the channel is busy, STA1 may be affected by a signal coming from the other BSS (e.g., BSS2).

According to an embodiment, adjusting the CCA threshold value and corresponding transmission power may be an option to improve system level performance and spectrum utilization. For example, when a high CCA threshold value is set, a packet with a relatively large signal strength may be ignored. When a packet with a high received signal strength is ignored and transmission (e.g., SR transmission) is performed, significant interference to transmission in progress (e.g., ongoing transmission) may occur. When a high CCA threshold value is applied and accordingly a packet with a high signal strength is ignored, STA1 that performs SR transmission may reduce a size of the transmission power to protect the transmission in progress (e.g., the ongoing transmission). When a low CCA threshold value is applied and accordingly only a packet with a sufficiently low signal strength is ignored, a level of interference caused by SR transmission may be expected to be low as well, and consequently, a larger amount of transmission power may be used for SR transmission.

According to an embodiment, the 802.11ax standard defines a regulation for a CCA threshold value (e.g., OBSS_PDₗₑᵥₑₗ) and available transmission power (e.g., TX_PWR) that correspond to the above description. The regulations defined by the 802.11ax standard may be confirmed in FIG. 5C. Each of the values shown in FIG. 5C is an example, and a gradient of the linear interval may be “−1.” In FIG. 5C, the horizontal axis may refer to a size of available transmission power, and the vertical axis may refer to a CCA threshold value. When the CCA threshold value is high, low transmission power may be used for SR transmission. When the CCA threshold value is low, high transmission power may be used for SR transmission.

According to an embodiment, the 802.11ax standard defines that SR transmission must satisfy the graph shown in FIG. 5C. The 802.11ax standard does not define a CCA threshold value to apply and/or a value of transmission power to use for SR transmission. For example, which values to be used remains an implementation issue for a device manufacturer (or a chipset manufacturer). The spatial reuse protocol and the SAR back-off protocol described with reference to FIGS. 4A and 4B have a common feature in that both control transmission power. Therefore, when the SAR back-off protocol is not considered in SR transmission, inefficiency in an operation of a spatial reuse protocol may occur.

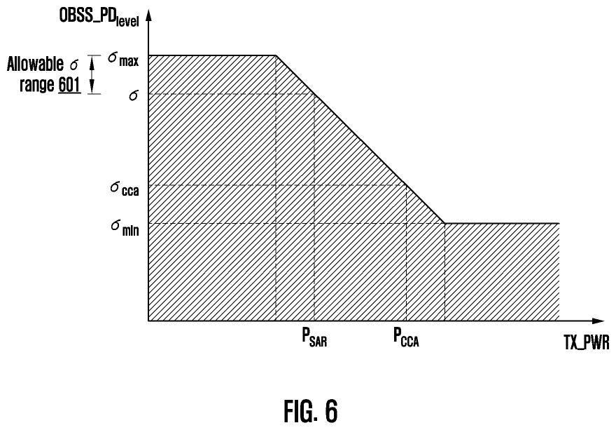

FIG. 6 is a graph illustrating a conflict between a spatial reuse protocol and a SAR back-off protocol, according to various embodiments.

Referring to FIG. 6, it may be confirmed that a CCA threshold value (σ_{cca}) and corresponding transmission power (P_{CCA}) may be set according to the spatial reuse protocol, and that a SAR back-off limit value (P_{SAR}) may be set according to the SAR back-off protocol. When only the spatial reuse protocol is considered, the CCA threshold value (σ_{cca}) may be set within a first range (σₘᵢₙ to σₘₐₓ). However, since the transmission power (P_{CCA}) corresponding to the CCA threshold value (σ_{cca}) may be greater than the SAR back-off limit value (P_{SAR}), SR transmission may not be performed using the transmission power (P_{CCA}). Thus, when the SAR back-off protocol is not considered in a CCA threshold value setting step, SR transmission using the transmission power (P_{CCA}) corresponding to the CCA threshold (σ_{cca}) may not be performed and meaningless occupancy of a communication channel may occur at the same time. When the spatial reuse protocol and the SAR back-off protocol are considered together, the CCA threshold value may need to be set within a second range (σ to σₘₐₓ) 601 including the CCA threshold value (σ) corresponding to the SAR back-off threshold value (P_{SAR}).

FIG. 7 is a block diagram illustrating an example configuration of an STA according to various embodiments.

Referring to FIG. 7, according to an embodiment, an STA 701 may perform communication, simultaneously considering a SAR back-off protocol and a spatial reuse protocol. The SAR back-off protocol may control transmission power in response to a regulation related to the human body electromagnetic waves absorption. The SR protocol may allow ignoring transmission in progress (e.g., ongoing transmission) and performing SR transmission when an influence of interference between STAs is small. The STA 701 may include a wireless communication module (e.g., including communication circuitry) 710 (e.g., a wireless communication module 1192 of FIG. 11), a processor (e.g., including processing circuitry) 720 (e.g., a processor 1120 of FIG. 11), and a memory 730 (e.g., a memory 1130 of FIG. 11). The wireless communication module 710 may include various communication circuitry and be configured to transmit and receive a wireless signal. The wireless communication module 710 may be a Wi-Fi chipset. The processor 720 may be operatively connected to the wireless communication circuit 710. The memory 730 may be electrically connected to the processor 720 and may store instructions executable by the processor 720. The STA 701 may correspond to an electronic device (e.g., the electronic device 1101 of FIG. 11) described below with reference to FIG. 11. Therefore, a description redundant with the description provided with reference to FIG. 11 may not be repeated here.

According to an embodiment, the processor 720 may include various processing circuitry and confirm whether a SAR back-off limit value for transmission power of the STA 701 exists. The SAR back-off limit value may be a power value. The processor 720 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions.

According to an embodiment, the processor 720 may set a spatial reuse parameter related to the transmission power of the STA 701, based on the SAR back-off limit value. The spatial reuse parameter may be a CCA threshold value for performing a CCA operation. The processor 720 may obtain a first CCA threshold value corresponding to the SAR back-off limit value. The processor 720 may obtain the first CCA threshold value, using a relationship between the CCA threshold value and the transmission power as defined by the 802.11ax standard. The processor 720 may adaptively set a third CCA threshold value that may be within a range of the first CCA threshold value to a second CCA threshold value. The second CCA threshold value may be a maximum value among allowable CCA threshold values. The processor 720 may set the third CCA threshold value to be close to the first CCA threshold value when a packet received via the wireless communication module 710 includes an intra-BBS frame. The processor 720 may set the third CCA threshold value to be close to the second CCA threshold value when the packet includes an inter-BBS frame.

According to an embodiment, the processor 720 may perform communication based on the spatial reuse parameter (e.g., the third CCA threshold value). The processor 720 may determine whether a communication channel is occupied, based on the third CCA threshold value. The processor 720 may perform the communication using the transmission power corresponding to the third CCA threshold value, based on the determination result (e.g., the communication channel is not occupied).

According to an embodiment, the processor 720 may calculate an energy budget allocated to a time window, based on a TAS back-off algorithm. The TAS back-off algorithm may be an algorithm that limits transmission power in terms of a total amount of electromagnetic wave energy emitted within a determined window (e.g., an averaging window). The TAS back-off algorithm may limit average transmission power during the averaging window to be less than or equal to a determined value. To meet the electromagnetic waves absorption rate regulations, the TAS back-off algorithm may update a TAS back-off limit value (e.g., a power limit value) in the unit of time window that is much smaller than the averaging window. Based on the energy budget allocated to a time window, the TAS back-off algorithm may set a back-off limit value to be applied to the time window.

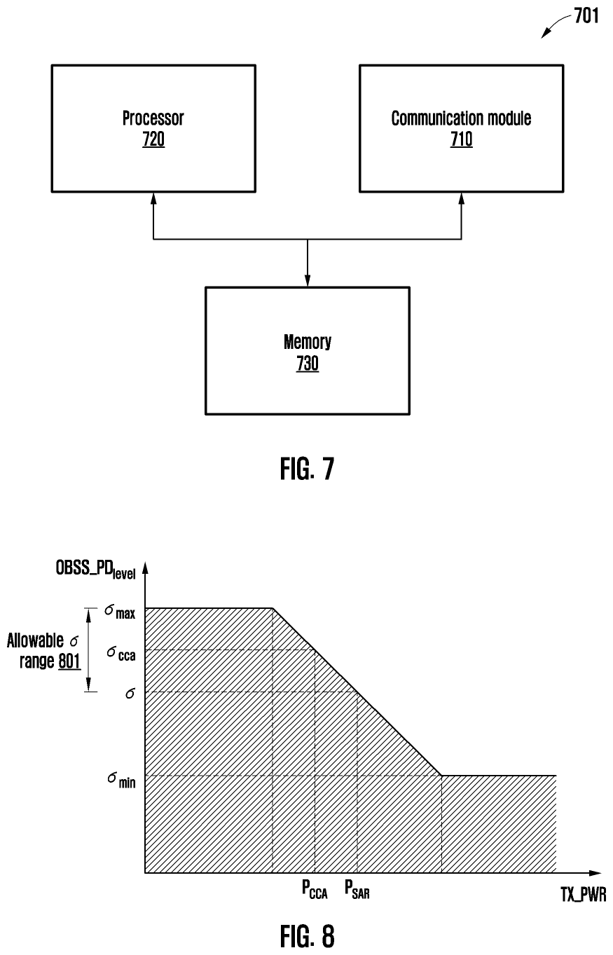

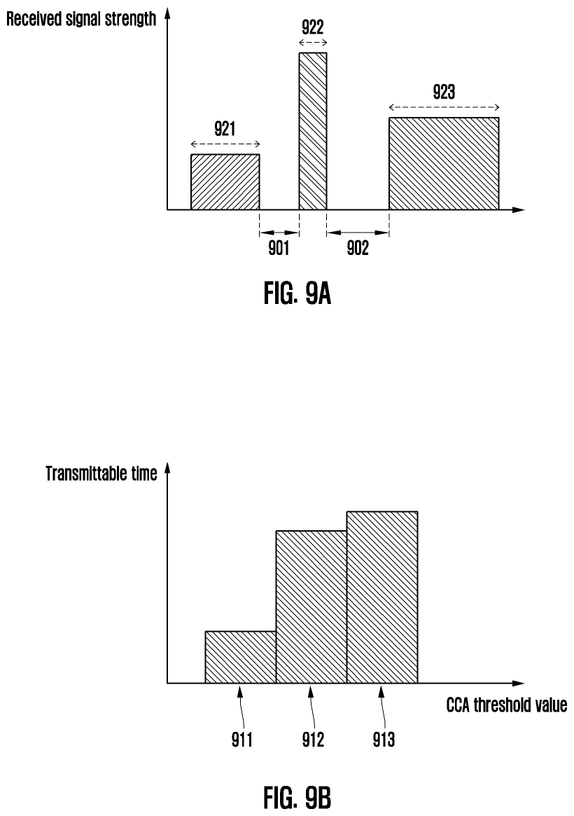

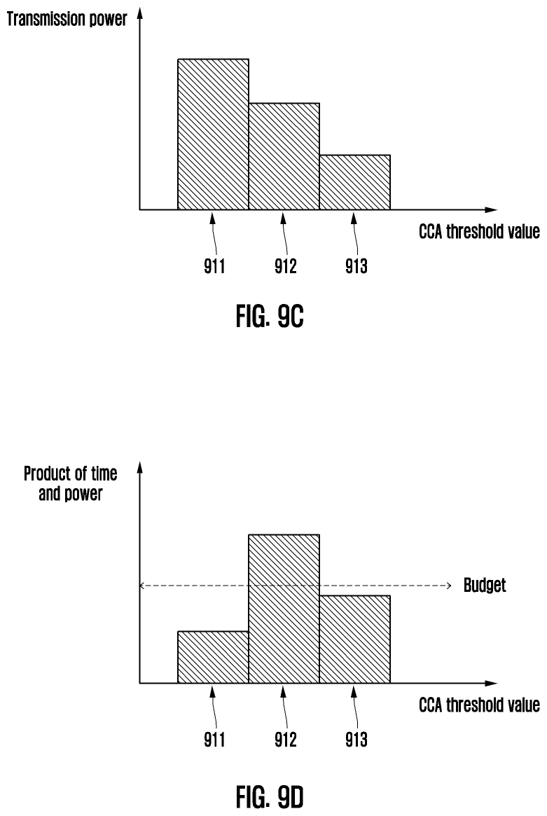

According to an embodiment, the processor 720 may set the spatial reuse parameter related to the transmission power of the STA 701, based on an energy budget. The spatial reuse parameter may be a CCA threshold value. The processor 720 may quantize a specified range (e.g., a range specified to obtain a CCA threshold value) to obtain a plurality of CCA threshold values (e.g., CCA threshold values 911, 912, and 913 shown in FIGS. 9B to 9D). The specified range (e.g., the range specified to obtain the CCA threshold value) and a quantization interval in the specified range may be set differently depending on a number of STAs connected to an AP, a neighboring BBS situation, and/or a traffic situation, and the CCA threshold values 911, 912, and 913 shown in FIGS. 9B to 9D may be an example. For each of the plurality of CCA threshold values, the processor 720 may calculate an energy margin that may be used during the time window. The processor 720 may obtain, from the plurality of CCA threshold values, CCA threshold value candidates with an energy margin that does not exceed the energy budget. Based on the CCA threshold value candidates, the processor 720 may adaptively set a CCA threshold value corresponding to the time window. The processor 720 may set the CCA threshold value corresponding to the time window, based on a packet error rate or a type of service being executed. For example, when a real-time service is being executed, the processor 720 may set a high CCA threshold value to actively obtain a transmission opportunity. For example, when the processor 720 performs communication based on a high CCA threshold value, the packet error rate may be high because transmission power of the processor 720 may be low and transmission power of transmission in progress (e.g., an ongoing transmission) may be high. Thus, the processor 720 may arbitrarily select one of the CCA threshold value candidates and monitor the packet error rate of communication being performed based on the selected CCA threshold value. When the packet error rate of the communication being performed based on the selected CCA threshold value is higher than an upper limit, the processor 720 may select, from among the CCA threshold value candidates, a CCA threshold value with a value lower than the selected CCA threshold value.

According to an embodiment, an energy margin may be obtained by the processor 720 by monitoring (or detecting) incoming signals. The energy margin may be obtained by the processor 720 by selecting, from among the incoming signals, an incoming signal with a signal strength less than the CCA threshold value, for each of the plurality of CCA threshold values. The energy margin may be obtained by the processor 720 by adding reception times of selected incoming signals and thus obtaining a transmittable time, for each of the plurality of CCA threshold values. The energy margin may be obtained by the processor 720 by obtaining, for each of the plurality of CCA threshold values, transmission power corresponding to the CCA threshold value. The energy margin may be obtained by the processor 720 by multiplying, for each of the plurality of CCA threshold values, the transmittable time by the transmission power.

According to an embodiment, the processor 720 may perform communication based on the spatial reuse parameter (e.g., the CCA threshold value). The processor 720 may determine, based on the CCA threshold value, whether the communication channel is occupied. The processor 720 may perform the communication using the transmission power corresponding to the CCA threshold value, based on the determination result (e.g., the communication channel is not occupied).

FIG. 8 is a graph illustrating an example of an operation of a SAR back-off protocol combined with a spatial reuse protocol, according to various embodiments.

Referring to FIG. 8, an example is shown in which a SAR back-off limit value (P_{SAR}) is set according to the SAR back-off protocol, and a CCA threshold value (σ_{cca}) and corresponding transmission power (P_{CCA}) are set according to the spatial reuse protocol, according to an embodiment. When the SAR back-off protocol and the spatial reuse protocol are considered simultaneously, the CCA threshold value (σ_{cca}) may be set within a range (σ to σₘₐₓ) 801. According to an embodiment, an STA (e.g., the STA 701 of FIG. 7) may obtain a CCA threshold value (σ) corresponding to the SAR back-off limit (P_{SAR}), using the relationship between the CCA threshold value and the transmission power as defined by the 802.11ax standard. The STA 701 may not perform a spatial reuse operation without wasting resources by adaptively setting the CCA threshold value (σ_{cca}) within the range of the CCA threshold value (σ) to the CCA threshold value (σₘₐₓ). Hereinafter, a TAS back-off protocol, among SAR back-off protocols, combined with the spatial reuse protocol is described in detail.

FIGS. 9A, 9B, 9C and 9D are graphs illustrating an example of an operation of a SAR back-off protocol combined with a spatial reuse protocol, according to various embodiments.

Referring to FIG. 9A, examples of incoming signals monitored (or detected) according to performing a CCA are shown, according to an embodiment. The processor (e.g., the processor 720 of FIG. 7) may monitor (or detect) the incoming signals over a determined period of time. Bar graphs 921, 922, and 923 of FIG. 9A may be time regions in which incoming signals with a power strength greater than a CCA threshold value were received. Regions 901 and 902 of FIG. 9A that are unoccupied may be time regions in which incoming signals with a signal strength less than the CCA threshold value were received. The processor 720 may perform transmission when an incoming signal is not detected (or may be ignored). That is, the processor 720 may perform transmission during reception times of incoming signals with a signal strength less than the CCA threshold value. For each of the plurality of CCA thresholds, the processor 720 may obtain a transmittable time by adding the reception times (e.g., times of the regions 901 and 902) of the incoming signals with a signal strength less than the CCA threshold value.

Referring to FIG. 9B, an example of transmittable times calculated for each of the plurality of CCA threshold values 911, 912, and 913 is shown, according to an embodiment. In FIG. 9B, for ease of description, it is illustrated that the plurality of CCA threshold values 911, 912, and 913 has intervals, not specified values, but a form of the CCA threshold values (e.g., specified values or specified intervals) is not limited thereto. As the CCA threshold value increases, more incoming signals may be ignored, and the processor 720 may secure more transmittable times.

Referring to FIG. 9C, an example of transmission power corresponding to each of the plurality of CCA threshold values 911, 912, and 913 is shown, according to an embodiment. The processor 720 may obtain transmission power corresponding to each of the plurality of CCA threshold values 911, 912, and 913, based on the relationship between the CCA threshold value and the transmission power as defined by the 802.11ax standard.

Referring to FIG. 9D, an example of an energy margin that may be used during a time window is shown, according to an embodiment. The processor 720 may obtain an energy margin by multiplying, for each of the plurality of CCA threshold values 911, 912, and 913, the transmittable time by the transmission power. According to a spatial reuse protocol, the energy margin that may be used during a time window may not exceed an energy budget allocated to the time window. The processor 720 may select, from among the plurality of CCA threshold values 911, 912, and 913, CCA threshold value candidates 911 and 913 with an energy margin that does not exceed the energy budget. Based on the CCA threshold value candidates 911 and 913, the processor 720 may adaptively set a CCA threshold value corresponding to a time window. The processor 720 may set the CCA threshold value corresponding to the time window, based on a packet error rate or a type of service being executed. For example, when a real-time service is running, the processor 720 may set a high CCA threshold value 913 to actively obtain a transmission opportunity. For example, when the processor 720 performs communication based on a high CCA threshold value, the packet error rate may be high because transmission power of the processor 720 may be low and transmission power of transmission in progress (e.g., an ongoing transmission) may be high. Thus, the processor 720 may arbitrarily select one (e.g., 913) from among the CCA threshold value candidates 911 and 913 and monitor the packet error rate of communication being performed based on the selected CCA threshold value 913. The processor 720 may select the CCA threshold value 911 with a value lower than the selected CCA threshold value 913 from among the CCA threshold value candidates 911 and 913 when the packet error rate of the communication performed based on the selected CCA threshold value 913 is higher than an upper limit.

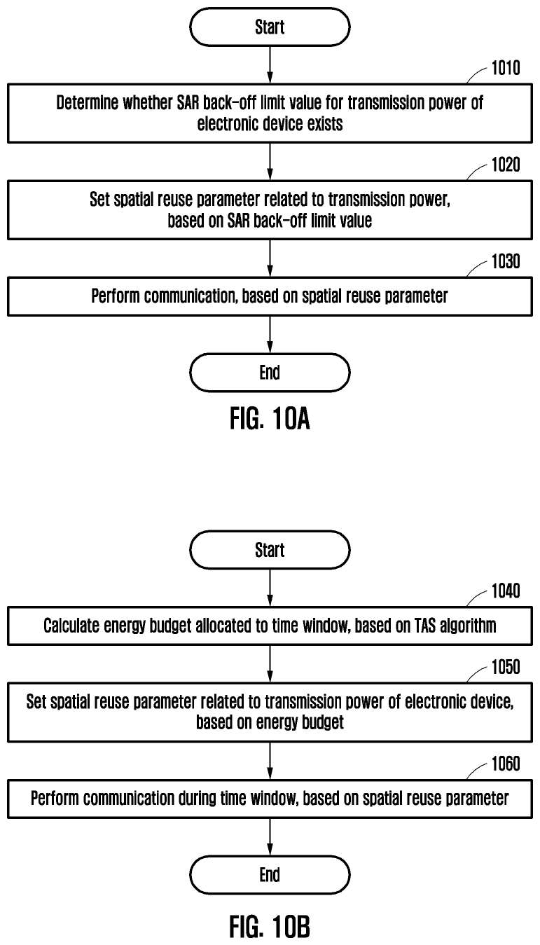

FIG. 10A is a flowchart illustrating an example method of operating an STA, according to various embodiments.

Operations 1010 to 1030 may be performed sequentially, but may not necessarily be performed sequentially. For example, the order of operations 1010 to 1030 may be changed, and at least two of operations 1010 to 1030 may be performed in parallel.

In operation 1010, the STA 701 (e.g., the STA 701 of FIG. 7) may determine whether a SAR back-off limit value for transmission power of the STA 701 exists.

In operation 1020, the STA 701 may set a spatial reuse parameter related to the transmission power, based on the SAR back-off limit value. The spatial reuse parameter may be a CCA threshold value. The STA 701 may obtain a first CCA threshold value corresponding to the SAR back-off limit value. The STA 701 may obtain a second CCA threshold value, which may be a maximum (e.g., the CCA threshold value (σₘₐₓ) of FIG. 8) among allowable CCA threshold values. The STA 701 may adaptively set a third CCA threshold value that may be within a range of the first CCA threshold value to the second CCA threshold value. For example, the STA 701 may set the third CCA threshold value to be close to the first CCA threshold value when a packet received via a wireless communication module includes an intra-BBS frame. For example, the STA 701 may set the third CCA threshold value to be close to the second CCA threshold value when the packet includes an inter-BBS frame.

In operation 1030, the STA 701 may perform communication, based on the spatial reuse parameter (e.g., the third CCA threshold value).

FIG. 10B is a flowchart illustrating an example method of operating an STA, according to various embodiments.

Operations 1040 to 1060 may be performed sequentially, but may not necessarily be performed sequentially. For example, the order of operations 1040 to 1060 may be changed, and at least two of operations 1040 to 1060 may be performed in parallel.

In operation 1040, the STA 701 (e.g., the STA 701 of FIG. 7) may calculate an energy budget allocated to a time window, based on the TAS back-off algorithm.

In operation 1050, the STA 701 may set a spatial reuse parameter related to transmission power of the electronic device, based on the energy budget. The spatial reuse parameter may be a CCA threshold value. The STA 701 may quantize a specified range (e.g., a range specified to obtain a CCA threshold value) to obtain a plurality of CCA threshold values (e.g., the CCA threshold values 911, 912, and 913 shown in FIGS. 9B to 9D). The specified range (e.g., the range specified to obtain the CCA threshold value) and a quantization interval of the specified range may be set differently depending on a number of STAs connected to an AP, a neighboring BBS situation, and/or a traffic situation. The STA 701 may calculate an energy margin that may be used during the time window, for each of the plurality of CCA threshold values 911, 912, and 913. The STA 701 may obtain, from the plurality of CCA threshold values 911, 912, and 913, CCA threshold value candidates 911 and 913 with an energy margin not exceeding the energy budget. Based on the CCA threshold value candidates 911 and 913, the STA 701 may adaptively set a CCA threshold value corresponding to the time window.

In operation 1060, the STA 701 may perform communication during the time window, based on the spatial reuse parameter (e.g., the CCA threshold value).

FIG. 11 is a block diagram illustrating an example electronic device 1101 in a network environment 1100, according to various embodiments.

Referring to FIG. 11, the electronic device 1101 in the network environment 1100 may communicate with an electronic device 1102 via a first network 1198 (e.g., a short-range wireless communication network), or communicate with at least one of an electronic device 1104 or a server 1108 via a second network 1199 (e.g., a long-range wireless communication network). According to an embodiment, the electronic device 1101 may communicate with the electronic device 1104 via the server 1108. According to an embodiment, the electronic device 1101 may include a processor 1120, a memory 1130, an input module 1150, a sound output module 1155, a display module 1160, an audio module 1170, a sensor module 1176, an interface 1177, a connecting terminal 1178, a haptic module 1179, a camera module 1180, a power management module 1188, a battery 1189, a communication module 1190, a subscriber identification module (SIM) 1196, or an antenna module 1197. In various embodiments, at least one of the components (e.g., the connecting terminal 1178) may be omitted from the electronic device 1101, or one or more other components may be added to the electronic device 1101. In various embodiments, some of the components (e.g., the sensor module 1176, the camera module 1180, or the antenna module 1197) may be integrated as a single component (e.g., the display module 1160).

The processor 1120 may include various processing circuitry and/or multiple processors. For example, as used herein, including the claims, the term “processor” may include various processing circuitry, including at least one processor, wherein one or more of at least one processor, individually and/or collectively in a distributed manner, may be configured to perform various functions described herein. As used herein, when “a processor”, “at least one processor”, and “one or more processors” are described as being configured to perform numerous functions, these terms cover situations, for example and without limitation, in which one processor performs some of recited functions and another processor(s) performs other of recited functions, and also situations in which a single processor may perform all recited functions. Additionally, the at least one processor may include a combination of processors performing various of the recited/disclosed functions, e.g., in a distributed manner. At least one processor may execute program instructions to achieve or perform various functions. The processor 1120 may execute, for example, software (e.g., a program 1140) to control at least one other component (e.g., a hardware or software component) of the electronic device 1101 connected to the processor 1120 and may perform various data processing or computations. According to an embodiment, as at least a part of data processing or computations, the processor 1120 may store a command or data received from another component (e.g., the sensor module 1176 or the communication module 1190) in a volatile memory 1132, process the command or the data stored in the volatile memory 1132, and store result data in a non-volatile memory 1134. According to an embodiment, the processor 1120 may include a main processor 1121 (e.g., a central processing unit (CPU) or an application processor (AP)), or an auxiliary processor 1123 (e.g., a graphics processing unit (GPU), a neural processing unit (NPU), an image signal processor (ISP), a sensor hub processor, or a communication processor (CP)) that is operable independently of, or in conjunction with the main processor 1121. For example, when the electronic device 1101 includes the main processor 1121 and the auxiliary processor 1123, the auxiliary processor 1123 may be adapted to consume less power than the main processor 1121 or to be specialized for a specified function. The auxiliary processor 1123 may be implemented separately from the main processor 1121 or as part of the main processor 1121.

The auxiliary processor 1123 may control at least some of functions or states related to at least one (e.g., the display module 1160, the sensor module 1176, or the communication module 1190) of the components of the electronic device 1101, instead of the main processor 1121 while the main processor 1121 is in an inactive (e.g., sleep) state or along with the main processor 1121 while the main processor 1121 is in an active state (e.g., executing an application). According to an embodiment, the auxiliary processor 1123 (e.g., an ISP or a CP) may be implemented as part of another component (e.g., the camera module 1180 or the communication module 1190) that is functionally related to the auxiliary processor 1123. According to an embodiment, the auxiliary processor 1123 (e.g., an NPU) may include a hardware structure specialized for artificial intelligence model processing. An artificial intelligence model may be generated by machine learning. Such learning may be performed, for example, by the electronic device 1101 in which the artificial intelligence model is executed, or via a separate server (e.g., the server 1108). Learning algorithms may include, but are not limited to, for example, supervised learning, unsupervised learning, semi-supervised learning, or reinforcement learning. The artificial intelligence model may include a plurality of artificial neural network layers. An artificial neural network may include, for example, a deep neural network (DNN), a convolutional neural network (CNN), a recurrent neural network (RNN), a restricted Boltzmann machine (RBM), a deep belief network (DBN), a bidirectional recurrent deep neural network (BRDNN), a deep Q-network, or a combination of two or more thereof, but is not limited thereto. The artificial intelligence model may additionally or alternatively include a software structure other than the hardware structure.

The memory 1130 may store various pieces of data used by at least one component (e.g., the processor 1120 or the sensor module 1176) of the electronic device 1101. The various pieces of data may include, for example, software (e.g., the program 1140) and input data or output data for a command related thereto. The memory 1130 may include the volatile memory 1132 or the non-volatile memory 1134.

The program 1140 may be stored as software in the memory 1130 and may include, for example, an operating system (OS) 1142, middleware 1144, or an application 1146.

The input module 1150 may receive, from the outside (e.g., a user) of the electronic device 1101, a command or data to be used by a component (e.g., the processor 1120) of the electronic device 1101. The input module 1150 may include, for example, a microphone, a mouse, a keyboard, a key (e.g., a button), or a digital pen (e.g., a stylus pen).

The sound output module 1155 may output a sound signal to the outside of the electronic device 1101. The sound output module 1155 may include, for example, a speaker or a receiver. The speaker may be used for general purposes, such as playing multimedia or playing a recording. The receiver may be used to receive an incoming call. According to an embodiment, the receiver may be implemented separately from, or as part of, the speaker.

The display module 1160 may visually provide information to the outside (e.g., a user) of the electronic device 1101. The display module 1160 may include, for example, a display, a hologram device, or a projector and control circuitry to control a corresponding device. According to an embodiment, the display module 1160 may include a touch sensor configured to sense a touch, or a pressure sensor configured to measure the intensity of force incurred by the touch.

The audio module 1170 may convert sound into an electrical signal or vice versa. According to an embodiment, the audio module 1170 may obtain the sound via the input module 1150 or output the sound via the sound output module 1155 or an external electronic device (e.g., the electronic device 1102, such as a speaker or headphones) directly or wirelessly connected to the electronic device 1101.

The sensor module 1176 may detect an operational state (e.g., power or temperature) of the electronic device 1101 or an environmental state (e.g., a state of a user) external to the electronic device 1101, and generate an electrical signal or data value corresponding to the detected state. According to an embodiment, the sensor module 1176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 1177 may support one or more specified protocols to be used for the electronic device 1101 to be connected to the external electronic device (e.g., the electronic device 1102) directly (e.g., by wire) or wirelessly. According to an embodiment, the interface 1177 may include, for example, a high-definition multimedia interface (HDMI), a universal serial bus (USB) interface, a secure digital (SD) card interface, or an audio interface.

The connecting terminal 1178 may include a connector via which the electronic device 1101 may be physically connected to the external electronic device (e.g., the electronic device 1102). According to an embodiment, the connecting terminal 1178 may include, for example, an HDMI connector, a USB connector, an SD card connector, or an audio connector (e.g., a headphones connector).

The haptic module 1179 may convert an electrical signal into a mechanical stimulus (e.g., a vibration or a movement) or an electrical stimulus, which may be recognized by a user via tactile sensation or kinesthetic sensation. According to an embodiment, the haptic module 1179 may include, for example, a motor, a piezoelectric element, or an electric stimulator.

The camera module 1180 may capture a still image and a moving image. According to an embodiment, the camera module 1180 may include one or more lenses, image sensors, image signal processors, or flashes.

The power management module 1188 may manage power supplied to the electronic device 1101. According to an embodiment, the power management module 1188 may be implemented as, for example, at least part of a power management integrated circuit (PMIC).

The battery 1189 may supply power to at least one component of the electronic device 1101. According to an embodiment, the battery 1189 may include, for example, a primary cell which is not rechargeable, a secondary cell which is rechargeable, or a fuel cell.

The communication module 1190 may support establishing a direct (e.g., wired) communication channel or a wireless communication channel between the electronic device 1101 and the external electronic device (e.g., the electronic device 1102, the electronic device 1104, or the server 1108) and performing communication via the established communication channel. The communication module 1190 may include one or more CPs that are operable independently of the processor 1120 (e.g., an AP) and that support direct (e.g., wired) communication or wireless communication. According to an embodiment, the communication module 1190 may include a wireless communication module 1192 (e.g., a cellular communication module, a short-range wireless communication module, or a global navigation satellite system (GNSS) communication module) or a wired communication module 1194 (e.g., a local area network (LAN) communication module or a power line communication (PLC) module). A corresponding one of these communication modules may communicate with the external electronic device 1104 via the first network 1198 (e.g., a short-range communication network, such as Bluetooth™, wireless-fidelity (Wi-Fi) direct, or infrared data association (IrDA)) or the second network 1199 (e.g., a long-range communication network, such as a legacy cellular network, a 5G network, a next-generation communication network, the Internet, or a computer network (e.g., a LAN or a wide area network (WAN)). These various types of communication modules may be implemented as a single component (e.g., a single chip) or may be implemented as multiple components (e.g., multiple chips) separate from each other. The wireless communication module 1192 may identify or authenticate the electronic device 1101 in a communication network, such as the first network 1198 or the second network 1199, using subscriber information (e.g., international mobile subscriber identity (IMSI)) stored in the SIM 1196.

The wireless communication module 1192 may support a 5G network after a fourth-generation (4G) network, and next-generation communication technology, for example, new radio (NR) access technology. The NR access technology may support enhanced mobile broadband (eMBB), massive machine type communications (mMTC), or ultra-reliable and low-latency communications (URLLC). The wireless communication module 1192 may support a high-frequency band (e.g., a mm Wave band) to achieve, for example, a high data transmission rate. The wireless communication module 1192 may support various technologies for securing performance on a high-frequency band, such as, e.g., beamforming, massive multiple-input and multiple-output (MIMO), full dimensional MIMO (FD-MIMO), an array antenna, analog beam-forming, or a large scale antenna. The wireless communication module 1192 may support various requirements specified in the electronic device 1101, the external electronic device (e.g., the electronic device 1104), or a network system (e.g., the second network 1199). According to an embodiment, the wireless communication module 1192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of 1 ms or less) for implementing URLLC.

The antenna module 1197 may transmit or receive a signal or power to or from the outside (e.g., the external electronic device). According to an embodiment, the antenna module 1197 may include an antenna including a radiating element including a conductive material or a conductive pattern formed in or on a substrate (e.g., a printed circuit board (PCB)). According to an embodiment, the antenna module 1197 may include a plurality of antennas (e.g., array antennas). In such a case, at least one antenna appropriate for a communication scheme used in a communication network, such as the first network 1198 or the second network 1199, may be selected by, for example, the communication module 1190 from the plurality of antennas. The signal or power may be transmitted or received between the communication module 1190 and the external electronic device via the at least one selected antenna. According to an embodiment, another component (e.g., a radio frequency integrated circuit (RFIC)) other than the radiating element may be additionally formed as a part of the antenna module 1197.

According to an embodiment, the antenna module 1197 may form a mmWave antenna module. According to an embodiment, the mmWave antenna module may include a PCB, an RFIC disposed on a first surface (e.g., the bottom surface) of the PCB or adjacent to the first surface and capable of supporting a designated high-frequency band (e.g., the mm Wave band), and a plurality of antennas (e.g., array antennas) disposed on a second surface (e.g., the top or a side surface) of the PCB, or adjacent to the second surface and capable of transmitting or receiving signals in the designated high-frequency band.

At least some of the above-described components may be coupled mutually and exchange signals (e.g., commands or data) therebetween via an inter-peripheral communication scheme (e.g., a bus, a general-purpose input and output (GPIO), a serial peripheral interface (SPI), or a mobile industry processor interface (MIPI)).

According to an embodiment, commands or data may be transmitted or received between the electronic device 1101 and the external electronic device 1104 via the server 1108 connected to the second network 1199. Each of the external electronic devices 1102 or 1104 may be a device of a type that is the same as or different from the electronic device 1101. According to an embodiment, all or some of operations to be executed by the electronic device 1101 may be executed by one or more external electronic devices (e.g., the external electronic devices 1102, 1104, or 1108). For example, when the electronic device 1101 needs to perform a function or a service automatically, or in response to a request from a user or another device, the electronic device 1101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and may transfer an outcome of the performing to the electronic device 1101. The electronic device 1101 may provide the outcome, with or without further processing of the outcome, as at least part of a reply to the request. To this end, cloud computing, distributed computing, mobile edge computing (MEC), or client-server computing technology may be used, for example. The electronic device 1101 may provide ultra low-latency services using, e.g., distributed computing or MEC. In an embodiment, the external electronic device 1104 may include an Internet-of-things (IoT) device. The server 1108 may be an intelligent server using machine learning and/or a neural network. According to an embodiment, the external electronic device 1104 or the server 1108 may be included in the second network 1199. The electronic device 1101 may be applied to intelligent services (e.g., a smart home, a smart city, a smart car, or healthcare) based on 5G communication technology or IoT-related technology.

The electronic device according to various embodiments disclosed herein may be one of various types of electronic devices. The electronic devices may include, for example, a portable communication device (e.g., a smartphone), a computer device, a portable multimedia device, a portable medical device, a camera, a wearable device, a home appliance, or the like. According to an embodiment of the disclosure, the electronic device is not limited to those described above.

It should be understood that an embodiment of the present disclosure and the terms used therein are not intended to limit the technological features set forth herein to particular embodiments and include various changes, equivalents, or replacements for a corresponding embodiment. With regard to the description of the drawings, similar reference numerals may be used to refer to similar or related elements. It is to be understood that a singular form of a noun corresponding to an item may include one or more of the things, unless the relevant context clearly indicates otherwise. As used herein, “A or B,” “at least one of A and B,” “at least one of A or B,” “A, B or C,” “at least one of A, B and C,” and “at least one of A, B, or C,” may include any one of the items listed together in the corresponding one of the phrases, or all possible combinations thereof. Terms such as “1st” and “2nd,” or “first” and “second” may be used to simply distinguish a corresponding component from other components, and do not limit the components in other aspects (e.g., importance or order). It is to be understood that if an element (e.g., a first element) is referred to, with or without the term “operatively” or “communicatively,” as “coupled with,” “coupled to,” “connected with,” or “connected to” another element (e.g., a second element), the element may be coupled with the other element directly (e.g., by wire), wirelessly, or via a third element.

As used in connection with an embodiment of the disclosure, the term “module” may include a unit implemented in hardware, software, or firmware, or any combination thereof, and may interchangeably be used with other terms, for example, “logic,” “logic block,” “part,” or “circuitry.” A module may be a single integral component or a minimum unit or part thereof, adapted to perform one or more functions. For example, according to an embodiment, the module may be implemented in a form of an application-specific integrated circuit (ASIC).

Embodiments as set forth herein may be implemented as software (e.g., the program 1140) including one or more instructions that are stored in a storage medium (e.g., an internal memory 1136 or an external memory 1138) that is readable by a machine (e.g., the electronic device 1101). For example, a processor (e.g., the processor 1120) of the machine (e.g., the electronic device 1101) may invoke at least one of the one or more instructions stored in the storage medium, and execute it. This allows the machine to be operated to perform at least one function according to the at least one instruction invoked. The one or more instructions may include code generated by a compiler or code executable by an interpreter. The machine-readable storage medium may be provided in the form of a non-transitory storage medium. Here, the “non-transitory” storage medium is a tangible device, and may not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program product may be traded as a product between a seller and a buyer. The computer program product may be distributed in the form of a machine-readable storage medium (e.g., a compact disc read-only memory (CD-ROM)), or be distributed (e.g., downloaded or uploaded) online via an application store (e.g., PlayStore™), or between two user devices (e.g., smartphones) directly. When distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities, and some of the multiple entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to embodiments, the integrated component may still perform one or more functions of each of the plurality of components in the same or similar manner as they are performed by a corresponding one of the plurality of components before the integration. According to an embodiment, operations performed by the module, the program, or another component may be carried out sequentially, in parallel, repeatedly, or heuristically, or one or more of the operations may be executed in a different order or omitted, or one or more other operations may be added.

According to an example embodiment, an electronic device (e.g., the STA 701 of FIG. 7 or the electronic device 1101 of FIG. 11) may include: at least one wireless communication module comprising communication circuitry (e.g., the wireless communication module 710 of FIG. 7 or the wireless communication module 1192 of FIG. 11) configured to transmit and/or receive a wireless signal, at least one processor, comprising processing circuitry (e.g., the processor 720 of FIG. 7 or the processor 1120 of FIG. 11), operatively connected to the wireless communication module; and a memory (e.g., the memory 730 of FIG. 7 or the memory 1130 of FIG. 11) storing instructions. The instructions, when executed by the at least one processor individually and/or collectively, may cause the electronic device to: determine whether a SAR back-off limit value for transmission power of the electronic device exists; set a spatial reuse parameter related to the transmission power, based on the SAR back-off limit value; and perform communication based on the spatial reuse parameter.

According to an example embodiment, the spatial reuse parameter may be a clear channel assessment (CCA) threshold value.

According to an example embodiment, the instructions, when executed by the at least one processor individually and/or collectively, may cause the electronic device to: obtain a first CCA threshold value corresponding to the SAR back-off limit value; and adaptively set a third CCA threshold value that may be within a range of the first CCA threshold value to the second CCA threshold value, wherein the second CCA threshold may be the maximum of the allowable CCA thresholds.

According to an example embodiment, the instructions, when executed by the at least one processor individually and/or collectively, may cause the electronic device to: set the third CCA threshold value to be within a specified range of the first CCA threshold value based on a packet received via the wireless communication module including an intra-BBS frame; set the third CCA threshold value to be within a specified range of the second CCA threshold value when the packet includes an inter-BBS frame.

According to an example embodiment, the instructions, when executed by the at least one processor individually and/or collectively, may cause the electronic device to: determine whether a communication channel is occupied based on the third CCA threshold value; and perform the communication using the transmission power corresponding to the third CCA threshold value, based on the determination result.

According to an example embodiment, the SAR back-off limit value may be a transmission power limit value of the electronic device.

According to an example embodiment, an electronic device (e.g., the STA 701 of FIG. 7 or the electronic device 1101 of FIG. 11) may include: at least one wireless communication module comprising communication circuitry (e.g., the wireless communication module 710 of FIG. 7 or the wireless communication module 1192 of FIG. 11) configured to transmit and/or receive a wireless signal, at least one processor, comprising processing circuitry (e.g., the processor 720 of FIG. 7 or the processor 1120 of FIG. 11), operatively connected to the wireless communication module; and a memory (e.g., the memory 730 of FIG. 7 or the memory 1130 of FIG. 11) storing instructions. The instructions, when executed by the at least one processor individually and/or collectively, may cause the electronic device to: calculate, based on the TAS back-off algorithm, an energy budget allocated to a time window; set a spatial reuse parameter related to transmission power of the electronic device, based on the energy budget; and perform communication during the time window, based on the spatial reuse parameter.

According to an example embodiment, the spatial reuse parameter may be a CCA threshold value.

According to an example embodiment, the instructions, when executed by the at least one processor individually and/or collectively, may cause the electronic device to: calculate, for each of a plurality of CCA threshold values an energy margin that may be used during the time window; obtain, from each of the plurality of CCA threshold values (e.g., the threshold values 911, 912, and 913 of FIG. 9), CCA threshold value candidates with the energy margin that does not exceed the energy budget; and based on the CCA threshold value candidates, adaptively set a CCA threshold value corresponding to the time window.

According to an example embodiment, the instructions, when executed by the at least one processor individually and/or collectively, may cause the electronic device to: obtain the energy margin by monitoring incoming signals. selecting, for each of the plurality of CCA threshold values, an incoming signal with a signal strength less than each of the plurality of CCA threshold values from among the incoming signals. For example, the processor 720 may select, for a first CCA threshold value (e.g., the CCA threshold value 911) among the plurality of CCA threshold values 911, 912, and 913, an incoming signal with a signal strength less than the first CCA threshold value (e.g., the CCA threshold value 911) from among the incoming signals. For example, the processor 720 may select, for a second CCA threshold value (e.g., the CCA threshold value 912) among the plurality of CCA threshold values 911, 912, and 913, an incoming signal with a signal strength less than the second CCA threshold value (e.g., the CCA threshold value 912) from among the incoming signals. For example, the processor 720 may select, for a third CCA threshold value (e.g., the CCA threshold value 913) among the plurality of CCA threshold values 911, 912, and 913, an incoming signal with a signal strength less than the third CCA threshold value (e.g., the CCA threshold value 913) from among the incoming signals.

The energy margin may be obtained by the processor 720 by adding reception times of selected incoming signals and thus obtaining a transmittable time, for each of the plurality of CCA threshold values 911, 912, and 913. The energy margin may be obtained by the processor 720 by obtaining, for each of the plurality of CCA threshold values 911, 912, and 913, transmission power corresponding to the CCA threshold value. The energy margin may be obtained by the processor 720 by multiplying, for each of the plurality of CCA threshold values 911, 912, and 913, the transmittable time by the transmission power.

According to an example embodiment, the instructions, when executed by the at least one processor individually and/or collectively, may cause the electronic device to: set a CCA threshold value corresponding to the time window, based on a packet error rate or a type of service being executed.

According to an example embodiment, the instructions, when executed by the at least one processor individually and/or collectively, may cause the electronic device to perform communication based on the higher CCA threshold value among the CCA threshold value candidates based on a real-time service being being executed.

According to an example embodiment, the TAS back-off algorithm may be an algorithm that limits average transmission power during an averaging window to a value less than or equal to a determined value.

According to an example embodiment, the instructions, when executed by the at least one processor individually and/or collectively, may cause the electronic device to determine whether a communication channel is occupied based on the CCA threshold value; and perform the communication using the transmission power corresponding to the CCA threshold value, based on the determination result.

A method of operating an electronic device (e.g., the STA 701 of FIG. 7 and the electronic device 1101 of FIG. 11) according to an example embodiment may include: determining whether a SAR back-off limit value for transmission power of the electronic device exists; setting a spatial reuse parameter related to the transmission power, based on the SAR back-off limit value; and performing communication based on the spatial reuse parameter.

According to an example embodiment, the spatial reuse parameter may be a CCA threshold value.

According to an example embodiment, the setting of the spatial reuse parameter may include: obtaining a first CCA threshold value corresponding to the SAR back-off limit value; adaptively setting a third CCA threshold value that may be within a range of the first CCA threshold value to the second CCA threshold value, wherein the second CCA threshold may be the maximum of the allowable CCA thresholds.

According to an example embodiment, the adaptive setting may include: setting the third CCA threshold value to be within a specified range of the first CCA threshold value based on a packet received via the wireless communication module including an intra-BBS frame, wherein the adaptive setting may include setting the third CCA threshold value to be within a specified range of the second CCA threshold value based on the packet including an inter-BBS frame.

According to an example embodiment, the performing of the communication may include: determining whether a communication channel is occupied based on the third CCA threshold value; and performing the communication using the transmission power corresponding to the third CCA threshold value, based on the determination result.

According to an example embodiment, the SAR back-off limit value may be a transmission power limit value of the electronic device.

While the disclosure has been illustrated and described with reference to various example embodiments, it will be understood that the various example embodiments are intended to be illustrative, not limiting. It will be further understood by those skilled in the art that various changes in form and detail may be made without departing from the true spirit and full scope of the disclosure, including the appended claims and their equivalents. It will also be understood that any of the embodiment(s) described herein may be used in conjunction with any other embodiment(s) described herein.

What is claimed is:

1. An electronic device comprising:
at least one wireless communication module comprising communication circuitry configured to transmit and/or receive a wireless signal;
at least one processor, comprising processing circuitry, operatively connected to the wireless communication module; and
a memory storing instructions,
wherein the instructions, when executed by the at least one processor individually and/or collectively, cause the electric device to:
determine whether a specific absorption rate (SAR) back-off limit value for transmission power of the electronic device exists;
set a spatial reuse parameter related to the transmission power, based on the SAR back-off limit value; and
perform communication based on the spatial reuse parameter.

2. The electronic device of claim 1, wherein the spatial reuse parameter is a clear channel assessment (CCA) threshold value.

3. The electronic device of claim 1, wherein the instructions, when executed by the at least one processor individually and/or collectively, cause the electronic device to further:
obtain a first CCA threshold value corresponding to the SAR back-off limit value;
adaptively set a third CCA threshold value within a range of the first CCA threshold value to a second CCA threshold value; and
the second CCA threshold value is a maximum among allowable CCA threshold values.

4. The electronic device of claim 3, wherein the instructions, when executed by the at least one processor individually and/or collectively, cause the electronic device to further:
set the third CCA threshold value to be within a specified range of the first CCA threshold value based on a packet received via the wireless communication module comprising an intra-basic service set (intra-BBS) frame; and
set the third CCA threshold value to be within a specified range of the second CCA threshold value based on the packet comprising an inter-BBS frame.

5. The electronic device of claim 3, wherein the instructions, when executed by the at least one processor individually and/or collectively, cause the electronic device to further:
determine whether a communication channel is occupied based on the third CCA threshold value; and
perform communication using transmission power corresponding to the third CCA threshold value, based on the determination result.

6. The electronic device of claim 1, wherein the SAR back-off limit value is a transmission power limit value of the electronic device.

7. An electronic device comprising:
at least one wireless communication module comprising communication circuitry configured to transmit and/or receive a wireless signal;
at least one processor, comprising processing circuitry, operatively connected to the wireless communication module; and
a memory storing instructions,
wherein the instructions, when executed by the at least one processor individually and/or collectively, cause the electric device to:
calculate an energy budget allocated to a time window, based on a time average specific absorption rate (TAS) back-off algorithm;
set a spatial reuse parameter related to transmission power of the electronic device, based on the energy budget; and
perform communication during the time window, based on the spatial reuse parameter.

8. The electronic device of claim 7, wherein the spatial reuse parameter is a clear channel assessment (CCA) threshold value.

9. The electronic device of claim 7, wherein the instructions, when executed by the at least one processor individually and/or collectively, cause the electronic device to further:
calculate, for each of a plurality of CCA threshold values an energy margin usable during the time window;
obtain, from the plurality of CCA threshold values, a CCA threshold value candidate with the energy margin that does not exceed the energy budget; and
adaptively set, based on the CCA threshold value candidate a CCA threshold value corresponding to the time window.

10. The electronic device of claim 9, wherein the energy margin is obtained by the instructions, when executed by the at least one processor individually and/or collectively, cause the electronic device to further:
monitor incoming signals;
select, for each of the plurality of CCA threshold values an incoming signal with a signal strength less than each of the plurality of CCA threshold values from among the incoming signals;
obtain a transmittable time by adding reception times of the selected incoming signals, for each of the plurality of CCA threshold values;
obtain transmission power corresponding to a CCA threshold value, for each of the plurality of CCA threshold values; and
multiply the transmittable time by the transmission power, for each of the plurality of CCA threshold values.

11. The electronic device of claim 9, wherein the instructions, when executed by the at least one processor individually and/or collectively, cause the electronic device to further:
set a CCA threshold value corresponding to the time window, based on a packet error rate or a type of service being executed.

12. The electronic device of claim 9, wherein the instructions, when executed by the at least one processor individually and/or collectively, cause the electronic device to further:
perform communication based on the higher CCA threshold value among the CCA threshold value candidates based on a real-time service being executed.

13. The electronic device of claim 7, wherein the TAS back-off algorithm is an algorithm that limits average transmission power during an averaging window to a value less than or equal to a determined value.

14. The electronic device of claim 8, wherein the instructions, when executed by the at least one processor individually and/or collectively, cause the electronic device to further:
determine whether a communication channel is occupied based on the CCA threshold value; and
perform communication using transmission power corresponding to the CCA threshold, based on the determination result.

15. A method of operating an electronic device, the method comprising:
determining whether a specific absorption rate (SAR) back-off limit value for transmission power of the electronic device exists;
setting a spatial reuse parameter related to the transmission power, based on the SAR back-off limit value; and
performing communication based on the spatial reuse parameter.

16. The method of claim 15, wherein the spatial reuse parameter is a clear channel assessment (CCA) threshold value.

17. The method of claim 15, wherein the setting of the spatial reuse parameter comprises:
obtaining a first CCA threshold value corresponding to the SAR back-off limit value; and
adaptively setting a third CCA threshold value within a range of the first CCA threshold value to the second CCA threshold value; and
wherein the second CCA threshold value is a maximum among allowable CCA threshold values.

18. The method of claim 17, wherein the adaptive setting comprises:
setting the third CCA threshold value to be within a specified range of the first CCA threshold value based on a packet received via the wireless communication module comprising an intra-basic service set (intra-BBS) frame; and
setting the third CCA threshold value to be within a specified range of the second CCA threshold value based on the packet comprising an inter-BBS frame.

19. The method of claim 17, wherein the performing of the communication comprises:
determining whether a communication channel is occupied based on the third CCA threshold value; and
performing communication using transmission power corresponding to the third CCA threshold value, based on the determination result.

20. The method of claim 15, wherein the SAR back-off limit value is a transmission power limit value of the electronic device.
